(19) United States
(12) Patent Application Publication
(10) Pub. No.: US 2022/0358714 A1
(43) Pub. Date: Nov. 10, 2022

(54) METHOD AND SYSTEM FOR AUTOMATICALLY DETECTING, LOCATING AND IDENTIFYING OBJECTS IN A 3D VOLUME

(71) Applicants: SISPIA, VINCENNES (FR); THALES, COURBEVOIE (FR)

(72) Inventors: Stefan BERECHET, VINCENNES (FR); Ion BERECHET, VINCENNES (FR); Gérard BERGINC, ELANCOURT (FR)

(21) Appl. No.: 17/621,433

(22) PCT Filed: Jul. 7, 2020
(86) PCT No.: PCT/EP2020/069056

§ 371 Date: Dec. 21, 2021

(30) Foreign Application Priority Data
Jul. 18, 2019 (FR) 1908109

(51) Int. Cl. G06T 15/20; G06T 11/00; G06V 10/25; G06V 10/26

(52) U.S. Cl. CPC G06T 15/205; G06T 11/003; G06V 10/25; G06V 10/26; G06V 2201/07

(57) ABSTRACT

Method and system for automatically detecting, locating and identifying objects in a 3D volume the method includes the following steps: from a 3D volume in voxels of the complex scene, obtaining k 2D cross sections in the 3D volume; for each input 2D cross section thus obtained, automatically detecting, locating and identifying objects of interest using a specialized artificial intelligence method designed to deliver, at output: a label corresponding to each object identified in the current input cross section (k); a 2D bounding box bounding each object thus labelled; a 2D icon defined by the 2D bounding box thus extracted; for each output 2D cross section, semantically segmenting each 2D icon defined by a 2D bounding box, and concatenating the results of all of the output 2D cross sections in 3D in order to generate the consolidated labels of the objects of interest, to generate 3D bounding boxes and to generate 3D icons segmented in this way.

### FIELD OF THE INVENTION

The invention relates to the automatic detection, location and identification of objects in a 3D volume.

It generally applies to the field of target detection, to the medical field, to the field of microelectronics, and also to similar fields. It makes it possible in particular to respond to application-based queries encountered in many situations, such as the automatic detection of small fossils (2-3 microns) in large 3D volumes reconstructed by scanning oil exploration core samples, the identification of camouflaged objects in a complex 3D scene; the identification of benign pigment disorders liable to progress to a carcinoma or a melanoma based on a three-dimensional skin reconstruction; the identification of “carcinogenic anomalies” in OCT (Optical Coherence Tomography) cross sections, or even the automatic detection, location and identification of carcinogenic tumours/deficient areas resulting from three-dimensional reconstructions of tomographic scans or MRI (Magnetic Resonance Imaging).

### CONTEXT OF THE INVENTION

At present, the abovementioned application-based queries are more often than not handled by an expert in the field (geophysicist, physicist, radiologist, dermatologist, etc.), who identifies the objects of interest in 3D volumes using viewing tools, such as for example the MIP (Maximum Intensity Projection).

However, the handling is difficult to carry out for the expert in the field because the mass of data to be processed is very large. In addition, the identification success rate by the expert in the field is limited and rarely exceeds 90%.

### SUMMARY OF THE INVENTION

The present invention aims to improve the situation.

To this end, the present invention proposes a method for detecting, locating and identifying objects contained in a complex scene.

According to a general definition of the invention, the method comprises the following steps:
from a 3D volume in voxels of the complex scene, obtaining k 2D cross sections in the 3D volume;
for each input 2D cross section thus obtained, automatically detecting, locating and identifying objects of interest using a specialized artificial intelligence method designed to deliver, at output:
   a label corresponding to each object identified in the current input 2D cross section;
   a bounding box bounding each object thus labelled;
   a 2D icon defined by the 2D bounding box thus extracted;
for each output 2D cross section, semantically segmenting each 2D icon defined by a 2D bounding box, and
concatenating the results of all of the k output 2D cross sections in order to generate the consolidated labels of the objects of interest, to generate 3D bounding boxes and to generate 3D icons segmented in this way.

The invention thus makes it possible to significantly improve the quality of the detection, location and identification of objects in a complex scene by virtue, on the basis of the 3D volume of the scene to be processed, of obtaining k 2D cross sections in each of which the objects to be processed are detected, located and identified through artificial intelligence and semantic segmentation and the results are concatenated in 3D. This gives the ability to detect, locate and identify objects automatically with very high accuracy even when the objects are masked from one another.

According to some preferred embodiments, the invention comprises one or more of the following features, which may be used separately or in partial combination with one another or in full combination with one another:
the complex scene is transformed beforehand into a 3D volume through 3D imaging;
   the method furthermore comprises a step of indexing the labels for all of the objects of interest in the complex scene;
   the resolution of the method depends on the number and the nature of the 2D cross sections;
   the resolution of the method depends on the size of the 2D bounding boxes;
   the resolution of the method depends on the size of the 3D bounding boxes.

Advantageously, the method comprises the following steps, in order to concatenate the results of all of the k output 2D cross sections in 3D, for one object of interest from among said objects of interest: defining, for each output 2D cross section, a local three-dimensional reference system, one of the dimensions of which is perpendicular to the plane defined by the 2D cross section, and associating said reference system with said 2D cross section; identifying, in the output 2D cross sections, subsets or slices of the object of interest; transforming each identified subset or slice of the object of interest by changing the reference system, from the local three-dimensional reference system of the 2D cross section to which it belongs to a predetermined absolute Cartesian reference frame; concatenating the transformed subsets or slices into a 3D icon.

The invention also relates to a system for implementing the method defined above.

The invention furthermore relates to a computer program comprising program instructions for executing a method as defined above when said program is executed on a computer.

Other features and advantages of the invention will become apparent on reading the following description of one preferred embodiment of the invention, given by way of example and with reference to the appended drawings.

### BRIEF DESCRIPTION OF THE DRAWINGS

FIG. 1 schematically illustrates the main steps of the method according to the invention;

FIG. 1A is an index table indexing the classes of objects of interest;

FIG. 2 schematically shows the steps of obtaining 2D cross sections;

FIG. 3 schematically shows the steps of automatically detecting, locating and identifying objects of interest in each 2D cross section using specialized artificial intelligence;

FIG. 4 shows a bounding box bounding the object detected in accordance with the method according to the invention;

FIG. 5 shows a segmented icon according to the invention;

FIG. 6 shows a 3D volume reconstructed in voxels according to the invention;

FIG. 7 shows main cross sections in a 3D volume reconstructed using receptive tomography according to the invention;

FIG. 8 shows one example of an OCT (Optical Coherence Tomography) cross section;

FIG. 9 shows one example of a complex 3D scene containing a camouflaged object reconstructed from 2D images using reflective tomography;

FIG. 10 shows one example of a 2D cross section in the 3D scene;

FIG. 11 shows the automatic detection and the generation of the bounding box bounding the camouflaged object in the 2D cross section of the 3D scene;

FIG. 12 shows the identification of the camouflaged object in the 2D cross section of the 3D scene; and

FIG. 13 shows the generation of the bounding box and the identification of the object in the 3D scene.

### DETAILED DESCRIPTION OF THE INVENTION

The invention relates to the automatic detection, location and identification of objects in three-dimensional (3D) imaging forming a three-dimensional (3D) volume in voxels (volumetric pixels).

For example and without limitation; 3D imaging corresponds to a complex scene in which objects may mask one another, as illustrated in FIG. 9.

In practice, the three-dimensional volume may be obtained using a transmission-based or fluorescence-based reconstruction method (Optical Projection Tomography, nuclear imaging or X-Ray Computed Tomography) or a reflection-based reconstruction method (reflection of a laser wave or using solar reflection in the case of the visible band (between 0.4 μm and 0.7 μm) or near infrared band (between 0.7 μm and 1 μm) or SWIR band (Small Wave InfraRed between 1 μm and 3 μm), or taking into account the thermal emission of the object (thermal imaging between 3 μm and 5 μm and between 8 μm and 12 μm); this three-dimensional reconstruction process is described in the patent “Optronic system and method dedicated to identification for formulating three-dimensional images” (U.S. Pat. No. 8,836,762B2, EP2333481B1).

All of the voxels resulting from a three-dimensional reconstruction with the associated intensity are used, this reconstruction having preferably been obtained through reflection.

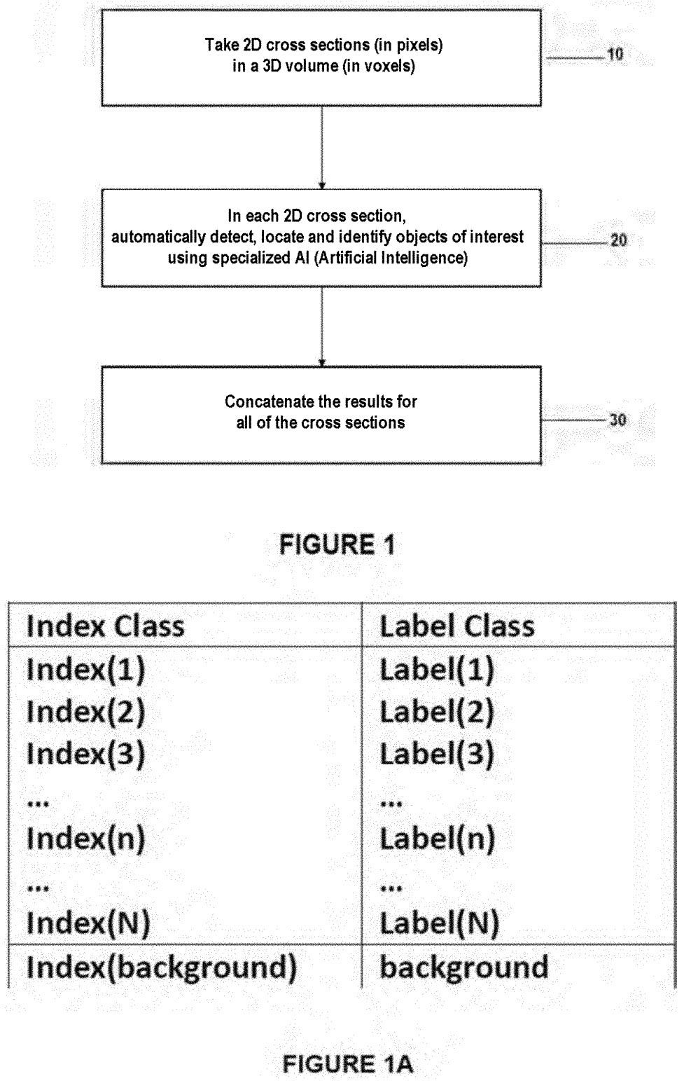

First of all, with reference to FIG. 1A, the classes of objects of interest are indexed.

A correspondence table TAB “Index Class×Label Class” for all of the classes of objects of interest is thus created. For example, at the end of the indexing, the following elements are obtained: Class(n)→{Index(n), Label(n)}, n={1, 2, . . . , N}, N being the number of classes of objects of interest.

By way of example, the Index(n) is at the value “n”, and the Index(background) is at the value “0”.

The detection, location and identification method according to the invention comprises the following general steps, which are described with reference to FIG. 1.

In a first step referenced 10, k 2D cross sections are taken in the reconstructed 3D volume. 3D volume→>{CrossSection(k)}, k={1, 2, . . . , K}, K being the number of 2D cross sections taken.

With reference to step 20, for each input 2D cross section thus obtained, the objects of interest are automatically detected, located and identified using a specialized artificial intelligence (AI) method.

The artificial intelligence (AI) method generates the following elements at output:
Detection of Objects(k,m) in the CrossSection(k), m={1, 2, . . . , M(k)}, M(k) being the number of objects detected in the CrossSection(k);
Generation of the Label(k,m) corresponding to each Object(k,m) identified in the CrossSection(k);
Generation of 2D bounding boxes, also called 2Dboundingbox(k,m) bounding each Object(k,m) in the CrossSection(k);
Extraction, from the CrossSection(k), of 2Dicons(k,m) defined by the 2D bounding boxes 2Dboundingbox(k,m).
   This thus gives the following elements: CrossSection(k)→{Object(k,m), Label(k,m), 2Dboundingbox(k,m), 2Dicon(k,m)}.

For example, the artificial intelligence (AI) method is based on the type of deep learning also known as “Faster R-CNN (Regions with Convolutional Neural Network features) object classification” deep learning.

Next, the method applies a semantic segmentation of each 2Dicon defined by a bounding box 2Dboundingbox.

In practice, the generation of a Segmented2Dicon(k,m) of the same size as the 2Dicon(k,m) has, for each pixel, either the value of the Index(k,m) of the Object(k,m) identified in the CrossSection(k), or the value of the Index(background). This therefore gives, at output, 2Dicon(k,m)→Segmented2Dicon(k,m).

For example, the semantic segmentation is performed using Deep Learning, for example a Mask R-CNN (Regions with Convolutional Neural Network) designated for the semantic segmentation of images.

With reference to step 30, the results of all of the 2D cross sections are finally concatenated in 3D.

In one set of embodiments of the invention, the results of the 2D cross sections are concatenated in 3D through the following steps:
Defining a local three-dimensional reference system associated with each 2D cross section, one of the dimensions of which is perpendicular to the plane defined by the 2D cross section,
Identifying 2D cross sections in which subsets or slices of the object of interest have been identified,
   Mathematically transforming (translating and/or rotating) all of the local three-dimensional reference systems of the selected subsets or slices into a determined absolute Cartesian three-dimensional reference frame.

This makes it possible to reconstruct the three-dimensional object while ensuring continuity at the limits of the subsets or slices of the object.

At the output, this then gives the following elements:

Concatenation of the Labels(k,m)→Generation of the consolidated Labels(n) Concatenation of the 2Dboundingboxes(k,m)→Generation of the 3Dboundingboxes(n)

### Concatenation of the Segmented2Dicons(k,m)→Generation of the Segmented3Dicons(n)

{Object(n), Label(n), 3Dboundingbox(n), Segmented3Dicon(k,n)}, (n) belonging to {1, 2, . . . , N}, N being the number of classes of objects of interest.

The method according to the invention exhibits multiple specific details.

The first specific detail, also called resolution, relates to the number and the angle of the 2D cross sections, for example the 2D cross sections belong to the group formed by main cross sections, horizontal cross sections, vertical cross sections, oblique cross sections. The higher the number of 2D cross sections, the better the detection resolution. In addition, 2D cross sections of different angles may provide better detection results and will be used in the 3D concatenation of the results, which will be described in more detail below.

The second specific detail relates to the 2D bounding boxes, 2Dboundingbox=[(x1,x2),(y1,y2)]. The smaller the size of the 2D bounding boxes, the better the detection resolution.

The third specific detail relates to the 3D bounding boxes, 3Dboundingbox=[(x1,x2),(y1,y2),(z1,z2)]. The smaller the size of the 3D bounding boxes, the better the detection resolution.

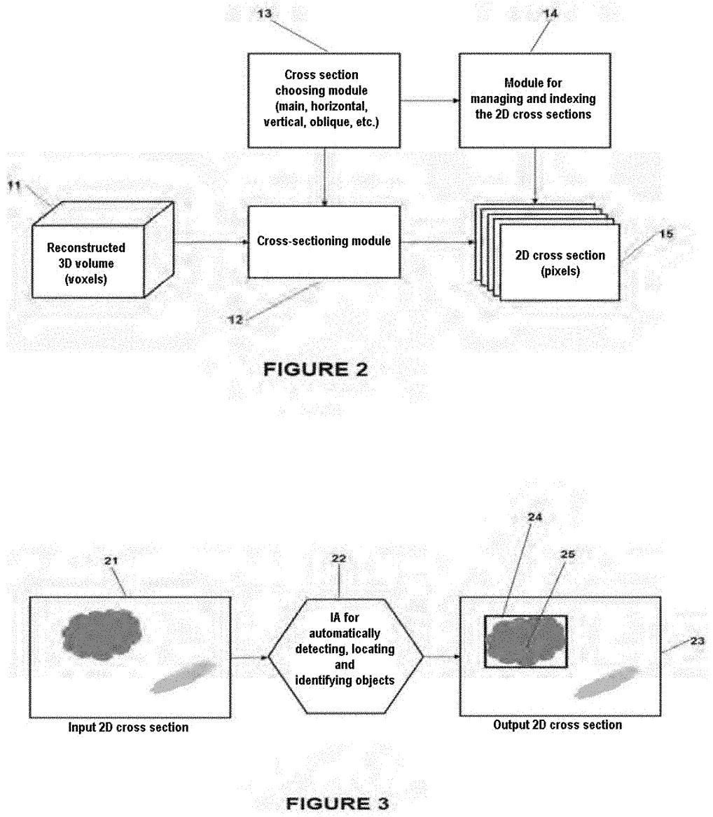

FIG. 2 shows the modules relating to the taking of the 2D cross sections.

As seen above, the choice and the number of 2D cross sections will impact the resolution of the detection.

From the 3D volume 11 (reconstructed in voxels), the cross-sectioning module 12 generates 2D cross sections 15 (in pixels) in response to the command from the choosing module 13. The 2D cross sections 15 (in pixels) are managed and indexed by the management module 14 in accordance with the indexing table TAB (FIG. 1A).

FIG. 3 shows the modules relating to the artificial intelligence (AI) method 22 applied to each input 2D cross section 21 generated and indexed in this way.

The output 2D cross section 23 generated by the AI method 22 comprises a 2D bounding box 24 bounding an object of interest 25.

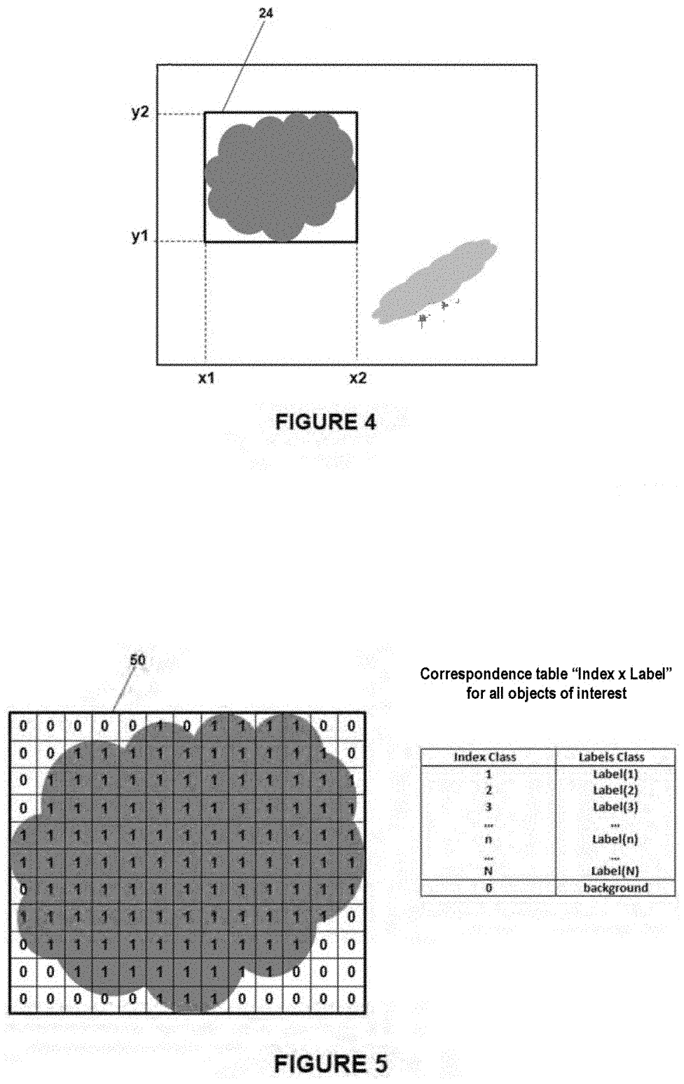

With reference to FIG. 4, the size of the 2D bounding box 24 bounding the object 25 is defined by its coordinates on the abscissa X (x1 and x2) and on the ordinate Y (y1 and y2).

FIG. 5 shows a 2D icon 50 semantically segmented according to the invention. For example, the object 25 is indexed with the value “1”, while the background is indexed with the value “0”.

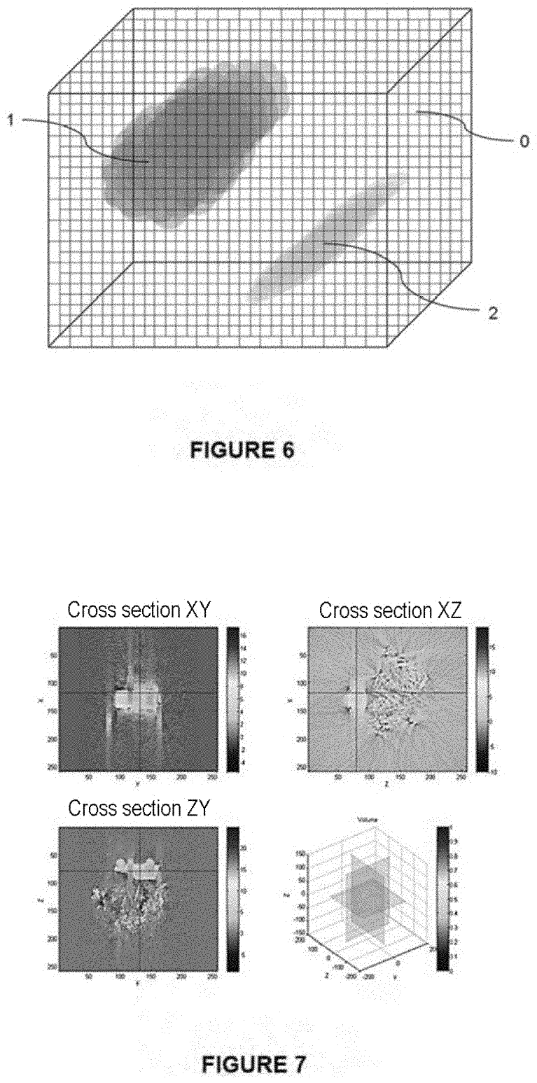

FIG. 6 shows a 3D volume reconstructed in voxels according to the invention, in which the object of interest 25 has the index “1”, while another object of interest has the index “2”; in a background volume of index “0”.

FIG. 7 shows main 2D cross sections in a 3D volume reconstructed using reflective tomography according to the invention, here along XY, XZ and ZY.

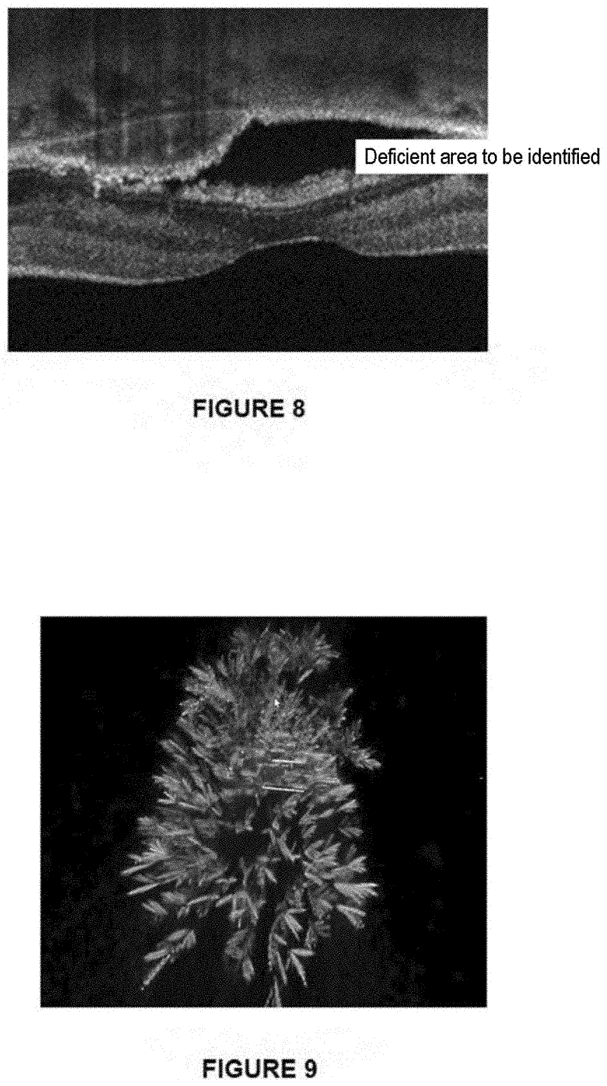

FIG. 8 shows one example of an OCT (Optical Coherence Tomography) cross section; in which a deficient area is to be identified.

FIG. 9 shows one example of a complex 3D scene containing a camouflaged object reconstructed from 2D images using reflective tomography.

For example, the complex scene contains a vehicle camouflaged in the bushes. The 2D shot is an air-to-ground shot with 2D images of 415×693 pixels.

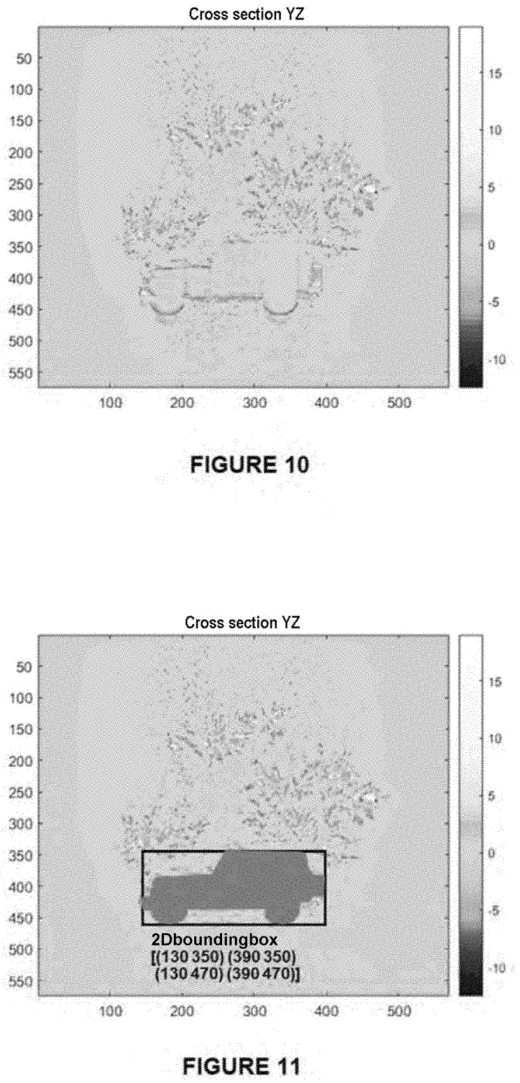

FIG. 10 shows one example of a 2D cross section (YZ cross section) in the 3D scene of FIG. 9.

FIG. 11 shows the automatic detection and generation of the bounding box bounding the camouflaged object in the 2D cross section of the 3D scene illustrated in FIGS. 9 and 10.

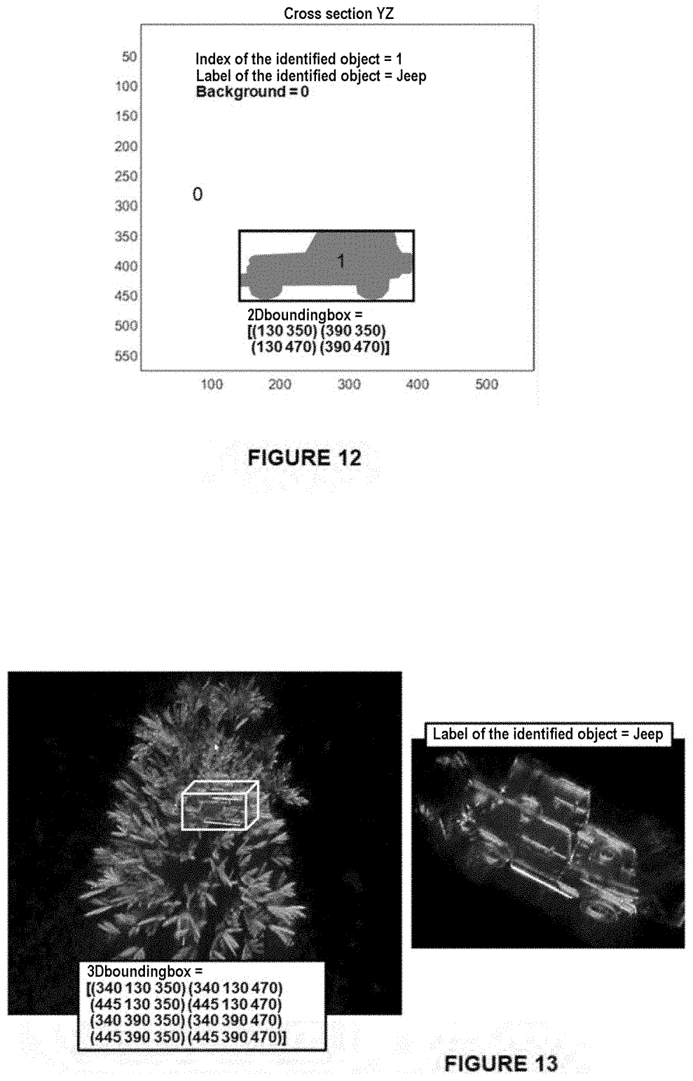

FIG. 12 shows the identification of the camouflaged object (index 1) in the 2D cross section of the 3D scene with the coordinates of the 2D bounding box.

FIG. 13 shows the generation of the 3D bounding box (with its coordinates) and the identification of the object in the 3D scene.

The fields of application of the invention are broad, covering the detection, classification, recognition and identification of objects of interest.

1. A method for detecting, locating and identifying objects contained in a complex scene, comprising the following steps:
from a 3D volume in voxels of the complex scene, obtaining k 2D cross sections in the 3D volume;
for each input 2D cross section thus obtained, automatically detecting, locating and identifying objects of interest using a specialized artificial intelligence method designed to deliver, at output:
a label corresponding to each object identified in the current input cross section;
a 2D bounding box bounding each object thus labelled;
a 2D icon defined by the 2D bounding box thus extracted;
for each output 2D cross section, semantically segmenting each 2D icon defined by a 2D bounding box, and
concatenating the results of all of the k output 2D cross sections in 3D in order to generate the consolidated labels of the objects of interest, to generate 3D bounding boxes and to generate 3D icons segmented in this way.

2. The method according to claim 1, wherein the complex scene is transformed beforehand into a 3D volume through 3D imaging.

3. The method according to claim 1, further comprising a step of indexing the labels for all of the objects of interest in the complex scene.

4. The method according to claim 1, wherein the resolution of the method depends on the number and the nature of the 2D cross sections.

5. The method according to claim 1, wherein the resolution of the method depends on the size of the 2D bounding boxes.

6. The method according to claim 1, wherein the resolution of the method depends on the size of the 3D bounding boxes.

7. The method according to claim 1, wherein the Artificial Intelligence (AI) method is based on the type of deep learning also known as Faster R-CNN (Regions with Convolutional Neural Network features) deep learning.

8. The method according to claim 1, wherein the semantic segmentation is performed using a Mask R-CNN (Regions with Convolutional Neural Network) convolutional neural network.

9. The method according to claim 1, comprising the following steps, in order to concatenate the results of all of the k output 2D cross sections in 3D, for one object of interest from among said objects of interest:
defining, for each output 2D cross section, a local three-dimensional reference system, one of the dimensions of which is perpendicular to the plane defined by the 2D cross section, and associating said reference system with said 2D cross section;
identifying, in the output 2D cross sections, subsets or slices of the object of interest;
transforming each identified subset or slice of the object of interest by changing the reference system, from the local three-dimensional reference system of the 2D cross section to which it belongs to a predetermined absolute Cartesian reference frame;
concatenating the transformed subsets or slices into a 3D icon.

10. A system for detecting, locating and identifying objects contained in a complex scene, comprising:
from a 3D volume in voxels of the complex scene, a module intended to obtain k 2D cross sections in the 3D volume;
an artificial intelligence module able, for each input 2D cross section thus obtained, to automatically detect, locate and identify objects of interest and designed to deliver, at output:
a label corresponding to each object identified in the current input cross section;
a 2D bounding box bounding each object (k,m) thus labelled;
a 2D icon defined by the 2D bounding box thus extracted;
a semantic segmentation module able, for each output 2D cross section, to semantically segment each 2D icon defined by a 2D bounding box, and
a processing module able to concatenate the results of all of the k output 2D cross sections in 3D in order to generate the consolidated labels of the objects of interest, to generate 3D bounding boxes and to generate 3D icons segmented in this way.

11. Computer program product comprising program instructions for executing a method according to claim 1 when said program is executed on a computer.
